(19) United States
(12) Patent Application Publication
(10) Pub. No.: US 2006/0218267 A1
(43) Pub. Date: Sep. 28, 2006

(54) Network, system, and application monitoring

(76) Inventors: Irfan Z. Khan, Minneapolis, MN (US); Mitchell Y. Coopet, Inver Grove Heights, MN (US); Matthew D. Dornquast, Minneapolis, MN (US); Richard C. Baker, Mahtomedi, MN (US)

Correspondence Address: Brooks & Cameron, PLLC;Suite 500, 1221 Nicollet Avenue, Minneapolis, MN, 55403, US

(21) Appl. No.: 11/088,576

(22) Filed: Mar. 24, 2005

(51) Int. Cl. G06F 15/173

(52) U.S. Cl. 709/224

(57) ABSTRACT

Systems, methods, and devices are provided for monitoring systems, networks, and applications. One method includes internally monitoring a network using a diskless and fanless hardware device. The method includes externally monitoring the network using a stateless connection and communicating internal network monitoring information to a third party data center using the stateless connection. The external monitoring information and internal monitoring information on the network is then converged into a unified view.

### BACKGROUND

Every company that depends on a computer network to operate is at risk if it does not monitor the ongoing health of that network. Without the ability to predict or anticipate, it can only react to a problem after it has surfaced. That is, without the ability to “see” the status/functionality of systems, networks, and applications it is very difficult to quickly address issues. Further, without such ability a company is also missing potentially significant cost savings or increased efficiencies due to lack of information.

Despite these risks and opportunities, most network-reliant companies do not monitor their networks. The reason for this is either lack of awareness of those risks and opportunities or the complexity and significant up-front and on-going expense of currently available monitoring tools, e.g., programs and devices. Most monitoring tools are geared toward people who understand monitoring. This typically means the tool is geared to companies large enough to afford in-house technical staff.

Prior approaches include third party use of external monitoring, e.g., monitoring from the outside of a network's firewall. As used herein, a network can be thought of as a planned hardware and software environment, e.g., a local area network (LAN), wide area network (WAN), etc. Monitoring a website from the “outside only” can give a “real” sense of what is actually happening from a user's perspective. By monitoring from a number of outside sites one can gather an accurate picture as to whether an application/service is responding as the application/service was intended. For example, a web site's load time from a multitude of global remote locations will help understand how users from around the world are experiencing the website. Monitoring the website from the same network segment as the webserver provides little information about load times, but rather only provides information as to whether the site is simply up or down. The other main advantage of monitoring from the outside is that the network equipment on the way from the external site to the application (e.g., website) is tested by association. If a firewall rule were mis-configured causing web traffic to be blocked, the external monitoring devices would pick up on this immediately.

Monitoring only from the outside can cause many false positives, i.e., alarms or concerns which do not really reflect an issue, when it comes to alerting a network administrator, operator, user, etc. What may look like an application failure may only be a brief maintenance window or outage by an upstream provider, e.g., internet service provider (ISP). Moreover, many applications such as Window's file sharing, e.g., common internet file system (CIFS), are not meant to be accessed over a WAN. Applications such as these are latency sensitive and may not respond well to requests from a remote location. What may be a timeout due to WAN latency may cause a false positive alert for a failure. Additionally, “heavy”, constant connection monitoring of services or polling of stats from a remote location may consume network resources, which may be precious on low bandwidth leased lines such as Frame Relay. A WAN failure on a remote location effectively blinds the administrator to all the activity that may be taking place within that remote location. Consider the following example: A factory, which uses the local network for running its production presses, is being monitored from an external site. The only application used outside the local network is email. If the WAN fails (e.g., a T1 line goes down), the external monitoring tool will perceive the factory's whole local network as down. The administrator would not know if the problem is limited to email, or if there is a larger failure such as a power outage or LAN failure that shut down factory operations, and may have to rush onsite to determine what happened.

The problem is exacerbated by the loss of data during this WAN outage. Because the monitoring tool cannot receive any stats from any system during this time, the job of downtime forensics is made increasingly difficult. Monitoring from the “outside in” usually requires the addition of firewall rules which allow the monitoring tool to successfully pass its requests into the “inside network”. This may open up the inside infrastructure to attacks and/or web traffic to services which should not or do not require external access.

Another approach includes software solutions installed internally within the firewall protecting a particular LAN. One advantage to monitoring “from the inside” of a network is the conservation of network/system resources. Typically a LAN is switched with 100 Mbps of available bandwidth per port. This capacity can allow for extensive monitoring of the network and the systems on it. Additionally, with inside monitoring a user (e.g., network administrator) can monitor a network's parameters which would not be advisable to do over a WAN. These parameters include information which could be used by a potential adversary to help exploit the network unless a secure connection such as a VPN (virtual private network) is used, i.e., a secure transport layer connection.

Unfortunately with this approach, applications which are offered as external resources and monitored from a device or program on the same network (LAN) give the administrator little information on the user experience of the application. For example, a monitoring tool directly connected to a web server is unable to accurately determine whether the server is available to the outside public over the WAN as the application was designed. That is, the upstream provider, e.g., ISP, may have had a failure and the website may actually be unavailable to the outside public, i.e., the audience for whom the application was intended.

In a remote office situation, e.g., branch office, disparate monitoring tools in each office give a poor tactical overview of the organization as a whole. To understand what is happening in each office, a central administrator may have to make a request to each of these networks separately to access the administration interface. In some systems a single view can be maintained by using a dedicated monitoring server. A dedicated monitoring server is considered to be a “best practice” when monitoring networks from the inside. In a multi-office setting the cost and staff maintenance burdens multiply rapidly. As a result, few companies use dedicated monitoring servers in each of their offices.

For an administrator, checking on the network from a remote location while having the monitoring tool inside the network poses additional challenges. For example, in order to view the network/systems the firewall needs to allow access from the outside. Unless, a secure connection, e.g., a VPN or selected access, is implemented the monitoring tools may be easily accessible to prying eyes. Also, if a given network is unavailable it may be difficult to view what is going on in the event of a network outage. Unless a RAS (remote access server) is implemented the administrator will be blind to what is going on inside the remote location.

Some approaches have attempted to combine internal software solutions with third party external monitoring services. These attempts have added some weaknesses depending on the given implementation. For example, the combination of these two types of checks may require the use of disparate hardware, programs, and methodologies. That is, administrators who implement the previously available types of monitoring may use a stand-alone software product for internal monitoring and then use a third party for external monitoring. When two different devices, programs, and/or methodologies do not talk to each other many problems such as double alerting (e.g., from two different sources simultaneously), false positives, and interface overload may occur. Interface overload, by way of example, is where the administrator has to go to two different places to get the information required. Attempts to combine data into one interface, e.g., in an open-source setting, generally involves advance configuration with associated expertise.

### BRIEF DESCRIPTION OF THE DRAWINGS

FIG. 1 is an embodiment of a network as may exist within a given company.

FIG. 2A is a block diagram of a system embodiment including an internal monitoring device connected to a company's systems, networks, and applications, and also to a remote data center.

FIG. 2B illustrates an embodiment for the electrical components of the internal monitoring device.

FIG. 3 illustrates a block diagram of a system embodiment provided to a company having multiple company offices geographically removed from one another.

FIG. 4 illustrates a block diagram of a system embodiment showing the redundancy for communicating with one or more data centers.

FIG. 5 is a block diagram of a system embodiment illustrating notification escalation and alert capabilities.

FIG. 6 is a screen shot illustrating a user interface embodiment of system, network, and application monitoring.

### DETAILED DESCRIPTION

Systems, devices, and methods are provided for system, network, and application monitoring. The methods can be performed by computer executable instructions (e.g., software, firmware, etc.) and/or logic to achieve the functionality described herein. One system embodiment includes a remote data center (maintained separate from a company's systems and networks) where administration and configuration can be performed. The system embodiment further includes an internal monitoring device, including logic and non-volatile memory, which can be attached to a company's network via standard network connections. According to embodiments, the internal monitoring device is a diskless and fanless hardware solution and can communicate with the remote data center in a stateless, i.e., without the use of a secure, continuous transaction layer, and connectionless, e.g., can use web requests according to hypertext transport protocol (HTTP), manner. The internal monitoring device is capable of monitoring the company's internal network/systems, e.g., using SNMP (simple network management protocol) to get statistics such as disk usage, processor usage, memory allocation, etc.

The internal monitoring device can record this data and update the remote data center on a periodic basis. According to embodiments, the device can compress and encrypt the data and send it to the remote data center via the Internet. According to various embodiments, if access to the Internet is interrupted, the internal monitoring device will automatically communicate by telephone line through a built in modem. If telephone line service is also interrupted, communication will be established through a built in cellular mechanism. Thus, the internal monitoring device, in various embodiments, has built-in “out of band” connectivity capabilities.

All upgrades to the device can be performed from the remote data center. For example, when a company logs into a published website of the remote data center, the administrator can reboot the devices in their network with the newest version of a flash application, which is the software which configures the devices. In other words, the hardware device can be controlled and configured over the Internet with no changes to the company's existing network, e.g., no software for the company to install. For example, the internal monitoring device can include a NAND type flash storage device which includes the operating system and which can be updated with the newest version of the software and/or operating system kernel provided from a remote source. In various embodiments, the operating system is an open source, non-Windows based solution, e.g., Linux, since Windows may be susceptible to worms and viruses.

The remote data center has the ability to receive network data from the internal device and can compile all of the information received into clear, intuitive reports and graphs that can be viewed in real time showing usage trends, system bottlenecks, etc. The remote data center has the ability to make this information viewable externally through a published website that is accessible with appropriate user IDs, passwords, etc. Thus, embodiments can provide a unified view of the entire network, both from inside and outside the network's firewall to provide an unmatched ability to pinpoint the cause of inefficiencies or failures, either within the LANs or the cables, telephone lines and satellites that link them together. Warning and alerts can be issued by via numerous means to a number of external devices such as a cell phone, laptops, PDAs, pagers, etc., and will automatically escalate notification up the company's chain of command while maintaining a record of who was responsible for what and what action was taken by whom. Logic associated with the system is built around dependencies which ascertain what has failed and what the effect is on the business, e.g., how each monitored device interrelates others in a company's network and system.

Example Company Network

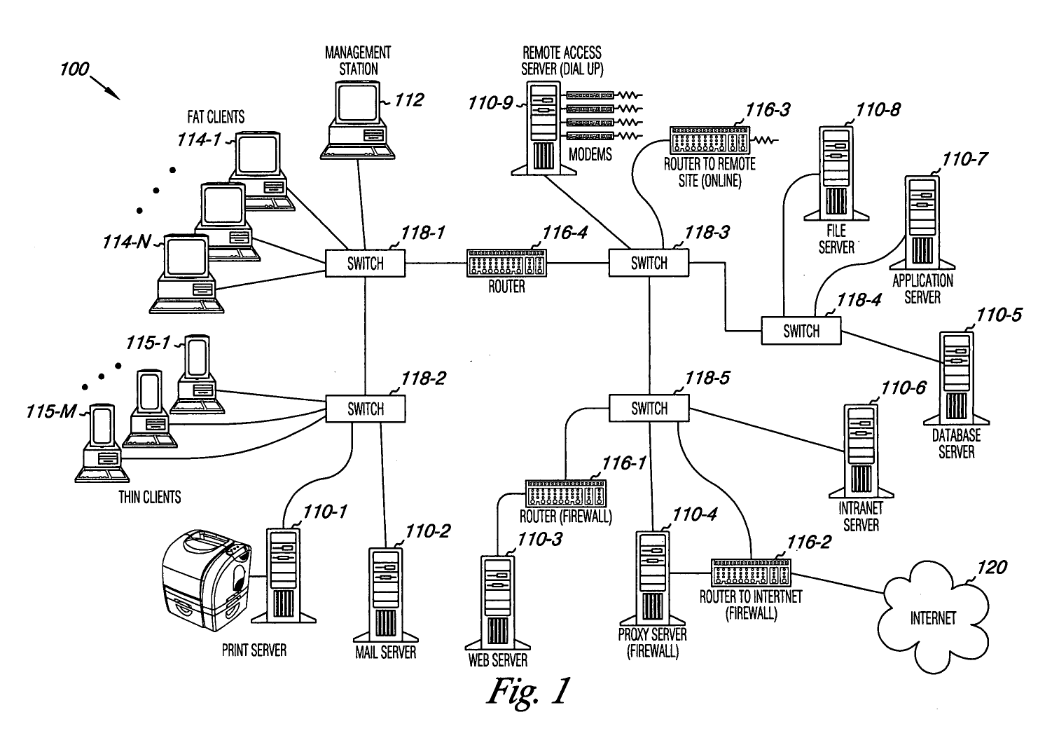

FIG. 1 is an embodiment of a network 100 as may exist within a given company. As shown in FIG. 1, a number of devices, e.g., PCs, servers, peripherals, etc., can be networked together via a local area network (LAN) (e.g., an Ethernet network), a wide area network (WAN), a wireless local area network (WLAN) the public switched telephone network (PSTN), and/or the Internet using transmission control protocol/Internet protocol (TCP/IP) via routers, hubs, switches and the like (referred to herein as “network devices”).

The embodiment of FIG. 1 illustrates clients and servers in a LAN. However, embodiments of the invention are not so limited. For example, the embodiment of FIG. 1 shows various servers for various types of services on a LAN. The example company network of FIG. 1 illustrates a print server 110-1 to handle print jobs for the network 100, a mail server 110-2, a web server 110-3, a proxy server (firewall), a database server 110-5, and intranet server 110-6, an application server 110-7, a file server 110-8, and a remote access server (dial up) 110-9. The examples provided here do not provide an exhaustive list. The example company network of FIG. 1 further illustrates a network management station 112, e.g., a PC or workstation, a number of “fat” clients 114-1, . . . , 114-N which can also include PCs and workstations and/or laptops, and a number of “thin” clients 115-1, . . . , 115-M which can include terminals and/or peripherals such as scanners, facsimile devices, handheld multifunction devices, e.g., PDAs, PC tablets, cellphones, pagers, and the like. The designators “N” and “M” are used to indicate that any number of fat or thin clients can be attached to the network 100. The number that N represents can be the same or different from the number represented by M.

The example company network of FIG. 1 illustrates that all of these example network devices can be connected to one another and/or to other networks via routers, 116-1, 116-2, 116-3, and 116-4, and hubs and/or switches 118-1, 118-2, 118-3, 118-4, and 118-5, as the same are known and understood by one of ordinary skill in the art. The network of FIG. 1 is further illustrated connected to the Internet 120 via router 116-2. As the reader will appreciate, the network 100 shown in FIG. 1 can additionally be connected to any type of radio frequency (RF) (e.g., GSM, ANSI, satellite, etc.), circuit-switched, (e.g., PSTN), and/or packet-switched network, etc. Embodiments of the invention are not limited to the number and/or type of network devices or the network architecture shown in FIG. 1's illustration.

As one of ordinary skill in the art will appreciate, many of these devices include processor and memory hardware. By way of example and not by way of limitation, the network management station 112 will include a processor and memory as the same are well known to one of ordinary skill in the art. Similarly, the network devices of routers, 116-1, 116-2, 116-3, and 116-4, hubs and/or switches 118-1, 118-2, 118-3, 118-4, and 118-5, and the number of fat clients 114-1, . . . , 114-N and the number of thin clients 115-1, . . . , 115-M, may include processor and memory resources. Embodiments of the invention are not limited, for the various devices in the network, to the number, type or size of processor and memory resources.

Program instructions (e.g., computer executable instructions) can reside on the various network devices for performing various functionalities, performing particular tasks, or providing particular services. For example, program instructions in the form of firmware, software, etc., can be resident on the network 100 in the memory of a network management station 112, of the number of “fat” clients 114-1, . . . , 114-N, of the number of “thin” clients 115-1, . . . , 115-M, of one or more routers, 116-1, 116-2, 116-3, and 116-4, hubs and/or switches 118-1, 118-2, 118-3, 118-4, and 118-5, and such program instructions can be executed by the processor(s) thereon. As the reader will appreciate, program instructions can be resident in a number of locations on various network devices in the network 100 as employed in a distributed computing network.

Embodiments within the scope of the present invention include computer-readable media having computer-executable instructions or data fields stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to store the desired computer-executable instructions. Combinations of the above are also included within the scope of computer-readable media.

Computer-executable instructions include, for example, instructions to cause a general purpose computer, special purpose computer, or special purpose processing device to perform a certain function or group of functions, routines, etc. In some contexts, the computer-executable instructions are described as program modules being executed by processor resources within a computing device. Generally, program modules include routines, programs, objects, data structures, etc. that perform particular tasks. As used herein, by way of example and not by way of limitation, a computing device can include servers, PDAs, PC tablets, cellular phones, laptops, desktops, etc.

Exemplary System

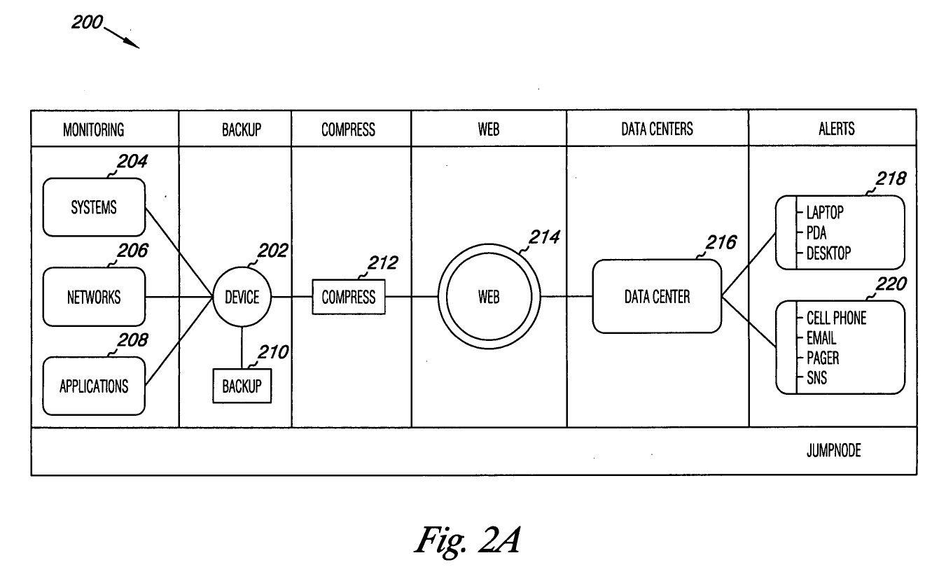

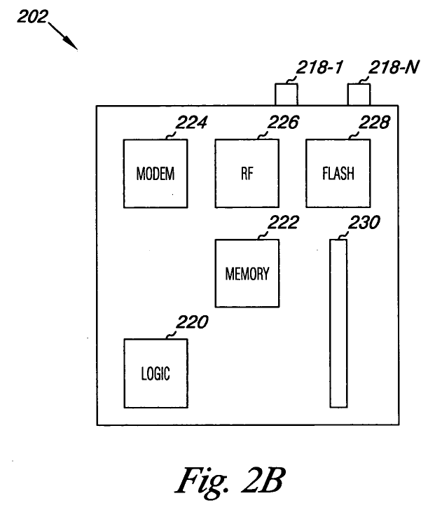

As noted above, embodiments of the present invention include systems, devices, and methods for system, network, and application monitoring. FIG. 2A is a block diagram of a system 200 embodiment including the above introduced internal monitoring device 202 connected to a company's systems 204, networks 206, and applications 208. As mentioned above the internal monitoring device includes logic and can be attached to a company's network via standard network connections. As will be described more in FIG. 2B, the internal monitoring device 202 can include internal memory to provide backup and storage, and can include one or more backup interfaces, illustrated at 210, to communicate and send and receive data. As shown in FIG. 2A, the internal monitoring device 202 can include logic and instructions for compression and encryption, illustrated at 212. For example, the logic can execute instructions to compress data using a known compression algorithms and can encrypt data using private key (asymmetric) and/or common key (symmetric) encryption techniques.

As shown in the embodiment of FIG. 2A, the internal monitoring device 202 can connect with one or more remote, third party data centers 216 in a stateless and connectionless manner. That is, the internal monitoring device 202 can connect with the one or more data centers 216 without the use of a secure transaction layer (e.g., without a private connection) by using web requests, e.g., stateless HTTP requests. The Internet, e.g., world wide web, is used as the transport layer for data transmission to the one or more data centers 216. A connection to the Internet can be made using one or more methods such as cellular, DSL, cable, and/or analog modem. Embodiments are not limited to these examples. And, as shown in the embodiment of FIG. 2A, the data centers 216 can issue alerts to fat 218 and thin 220 clients. As described in connection with FIG. 1, these fat 218 and thin 220 clients can include laptops, PDA, desktops, cell phones, email, pagers, SMS (short message service) devices, etc.

According to embodiments, the internal monitoring device 202 includes program instructions that execute to exchange data (e.g., information relating to systems within a network such as a server) with the one or more data centers 216 via temporary, stateless HTTP requests. That is, the connection is maintained between the internal monitoring device 202 and the one or more data centers 216 only for the immediate request, and then connection is closed without establishing a session which maintains state information. As the reader will appreciate, “virtual” in the context of networks refers to a virtual private network (VPN) which allows one network privileged access to another network, often remote. This requires setup work by parties of all participating networks. It also requires a user to authenticate themselves to establish a “session” on the remote network during which the user is granted access to the remote network's resources. This “session” maintains “state” information such as whether or not the user is authorized for access or if the session has exceeded idles time limits. Thus, network connections that establish sessions are stateful. Most modern applications maintain state, which means that they remember what was occurring the last time the program executed instructions, as well as configuration settings. By contrast, stateless implies having no information about what occurred previously. The temporary, stateless HTTP requests, or web requests, employed by the program instructions described herein are intrinsically stateless.

FIG. 2B illustrates an embodiment for the electrical components of the internal monitoring device 202. The internal monitoring device 202 is a diskless and fanless hardware solution and can be shipped and connected to a network at any company location. As shown in the embodiment of FIG. 2B, the device can include a number of connection ports 218-1, . . . , 218-N, of various types, e.g., USB (universal serial bus), RJ-11, etc., for forming a connection to a given company's network at any location or site. The internal monitoring device 202 includes logic 220 and memory 222. For example, the internal monitoring device 202 can be built around a RISC (reduced instruction set computing) processor with an ASIC (application specific integrated circuit) in order to perform its logic functions.

As shown in FIG. 2B, the internal monitoring device 202 includes a modem 224 and an RF transceiver 226 for cellular capabilities. In this manner, the internal monitoring device 202 can provide out-of-network, or out-of-band connectivity. For example, in the event that the internal monitoring device 202 is unable to connect with the one or more remote data centers 216 via a web request the internal monitoring device 202 can execute instructions to communicate with the one or more remote data centers 216 by telephone line via the built in modem 224. If telephone line service is also interrupted, communication can be established through the built in cellular capability of the RF transceiver 226. The internal monitoring device 202 includes a non-volatile memory 228 such as a NAND flash memory for storing instructions, including operating system instructions. In the unlikely event that all of the above mentioned communication methods fail, the internal monitoring device 202 will execute instructions to automatically store, e.g., in the NAND flash, all network information for later analysis once it regains connection to the one or more remote data centers 216.

According to various embodiments the operating system includes a Linux kernel which is designed for the application described herein. The Linux kernel, i.e., operating system, reduces the threat of worms and viruses. The internal monitoring device 202 can further include a serial card slot 230. Other electronic circuitry and components can further be included, as the same are known and understood in the art, to provide electrical connections between the components illustrated. Embodiments are not limited to the example components shown in FIG. 2B.

Exemplary Remote Data Centers/Multiple Company Offices

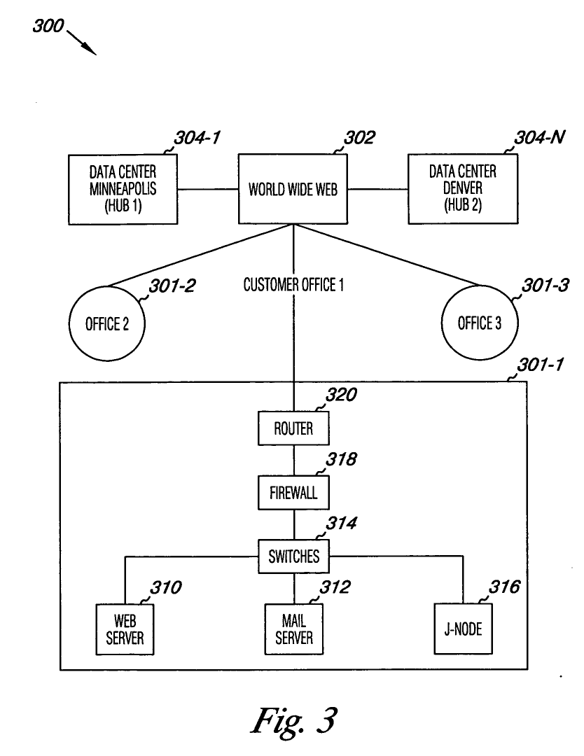

FIG. 3 illustrates a block diagram of a system 300 embodiment provided to a company having multiple company offices geographically removed from one another, e.g., Los Angeles, New York, and Boston. In FIG. 3 these are listed as Office 1 (labeled 301-1), Office 2 (labeled 301-2), and Office 3 (labeled 301-N). As one of ordinary skill in the art will appreciate upon reading this disclosure, any number of geographically separated offices can be monitored using the embodiments described herein and having an internal monitoring device 316 (labeled “J-node” in FIG. 3) shipped and connected to the company's network at each location.

In the embodiment of FIG. 3, the Office 1 (301-1) is shown in expanded detail to illustrate the interconnection of various network devices (such as described in FIG. 1) at this particular site. Thus, Office 1 (301-1) includes a web server 310 and a mail server 312 connected via network switches 314. In this embodiment, the internal monitoring device 316 is also illustrated connected to the office's network via switches 314. A router 320 is similarly illustrated in this diagram. As the reader will appreciate, routers such as router 320 can be connected to the network of a given office location both inside and outside of one or more firewall 318 protections provided to the network of the office.

According to the embodiments, the internal monitoring device 316 is connected to the location's network inside of the firewall 318 in order to provide internal monitoring tasks. As mentioned above, the internal monitoring device 316 embodiments are provided with program instructions, storable in flash memory, and executable by logic to perform various network monitoring functions internal to the particular LAN, e.g., 301-1. For example, program instructions may be provided to a NAND flash memory on the internal monitoring device 316 and executed by logic thereon to check and/or verify LAN security, VoIP (voice over IP) readiness and/or quality of service, quality of applications, etc. As the reader will appreciate, the instructions can execute according to SNMP (simple network management protocol) to get statistics such as disk usage, processor usage, memory allocation, etc. Likewise, the instructions can execute according to hypertext transport protocol (HTTP), file transfer protocol (FTP), transmission control protocol/internet protocol (TCP/IP), user datagram protocol (UDP), and internet control message protocol (ICMP), etc.

As shown in the embodiment of FIG. 3, the internal monitoring device 316, connected to a LAN at any business location or site, will connect with one or more data centers 304-1, . . . , 304-N, via the Internet using web requests, i.e. stateless HTTP requests, as described above. As the reader will appreciate, any number of remote data centers can be added to the system 300 embodiments described herein to afford unmatched redundancy over previous monitoring approaches. Companies using currently available monitoring products face significant risks if the product, or the computers on which the software product resides, fails. Previously, the only way to reduce that risk was to purchase multiple copies of the monitoring products each to be used on a computer attached to each of the separate networks. Previously, companies that purchase currently available software face the necessity of receiving updated versions that must be installed on their systems, either via software downloads or disks sent through the mail. To keep costs down, companies that sell monitoring software hold back on updates until a certain threshold number is reached-a risky policy for the customer.

The one or more data centers 304-1, . . . , 304-N include secure servers, e.g., high-powered enterprise class hardware. According to the embodiments, the servers are where the administration and configuration takes place. That is, all upgrades occur on the secure servers in the one or more data centers 304-1, . . . , 304-N ensuring that proprietary and company confidentiality is maintained. The software executing on these servers can be revised to optimize performance on a continuing basis without any action required by the company/customer who has installed one or more internal monitoring device 316 on their networks and/or systems.

Even more products, features, and services can be offered through the published website and downloaded to a given host, e.g., LAN to which a given internal monitoring device 316 is connected, using the same web request mechanism described earlier. The upgrades, additional products, features, and services will be provided to update the operating system in the flash memory of a given internal monitoring device 316. The internal monitoring device 316 thus get their instructions and updates from the one or more data centers 304-1, . . . , 304-N on what to monitor. Thus, a company using these embodiments will not need to purchase any additional hardware, train any staff, or configure any software and costly upgrades are avoided. According to various embodiments, program instructions on the system 300 execute to download and receive instructions and updates from the one or more data centers 304-1, . . . , 304-N only when instructions and/or updates are needed. That is, the program instructions can execute to verify if a most recent version is available on a given internal monitoring device and only transmit information and/or perform updates if something is needed or has changed. In this manner, bandwidth use is lessened.

According to the embodiments, the internal monitoring devices 316 offer plug-and-play simplicity. In other words, a company can sign up for initial service, or add services, via a published website, in a matter of minutes. The same day a completely configured internal monitoring device 316 (e.g., configured to the specifications/descriptions and type of monitoring requested, as given in the example above, for a particular company's network site) will be sent to the company. In some embodiments, a company can use the published website to self configure internal monitoring devices 316 to the specification/descriptions and type of monitoring desired bases on their known network and/or system needs. The company then simply plugs the internal monitoring device 316 into its network and monitoring can begin immediately. The internal monitoring device 316 can then begin sending information, e.g., data about the network, to the one or more data centers via web requests.

As the reader will appreciate upon reading this disclosure, the program embodiments described herein facilitate a method for network monitoring. Embodiments include making available a diskless and fanless internal monitoring hardware device 316 useable for internal network monitoring. As described, the device is connectable to a network, e.g., Office 1, without requiring any software reconfiguration to the network. The device 316 can exchange information with a data center 304-1, . . . , 304-N external to the network in a stateless manner. As the reader will appreciate, the purchase of the device can be facilitated via a website. A purchase can be made by any individual or entity including; a value added reseller (VAR), a purchaser internal to a company, a purchaser external to a company, a third party, etc. According to various embodiments, program instructions are executable via the website to download software tools to an individual and/or entity. The software tools include program instructions that can execute to probe the network for network items to monitor, and logically determine which network items should and should not be monitored. Using this information, the software tool can further execute instructions to configure the diskless and fanless internal monitoring hardware device 316 appropriately for internal network monitoring.

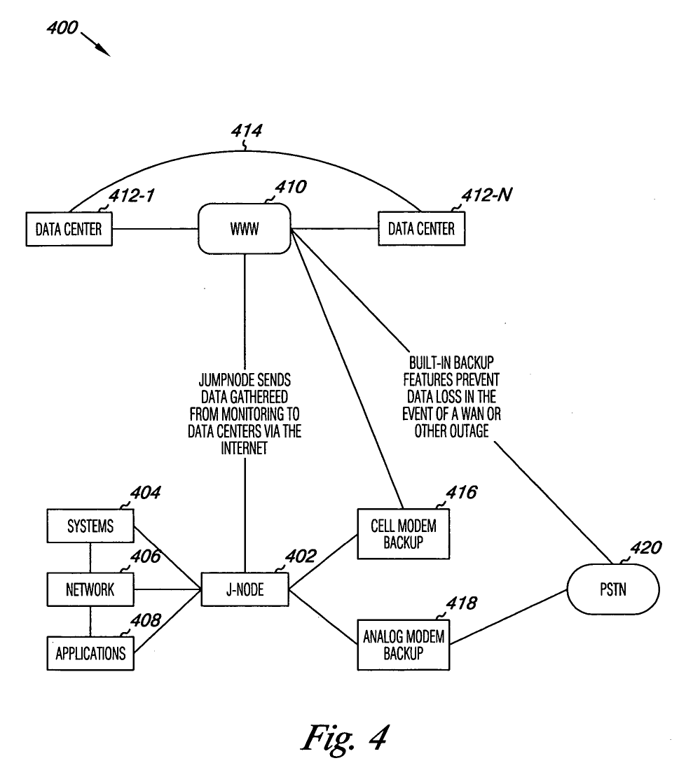

The internal monitoring device 316 does all the monitoring of the company's internal systems and networks (e.g., disk space on an Exchange Server). The internal monitoring devices 316 are powerful and focused on gathering information about the company's internal systems, networks, and applications. Program instructions on the internal monitoring device 316 execute such that upon attachment to a network, the internal monitoring device 316 will seek out all devices for potential monitoring. The internal monitoring device 316 will execute its program instructions to continually assess whether each designated computer, router, switch, etc., is functioning appropriately, e.g., how much capacity remains in each server and how much capacity (bandwidth) remains on the network. A given company may even add custom designed checks to the internal monitoring device 316. The internal monitoring device 316 will record all of this data and update the one or more data centers 304-1, . . . , 304-N on a periodic basis via the web requests or other backup interface (discussed in more detail in connection with FIG. 4).

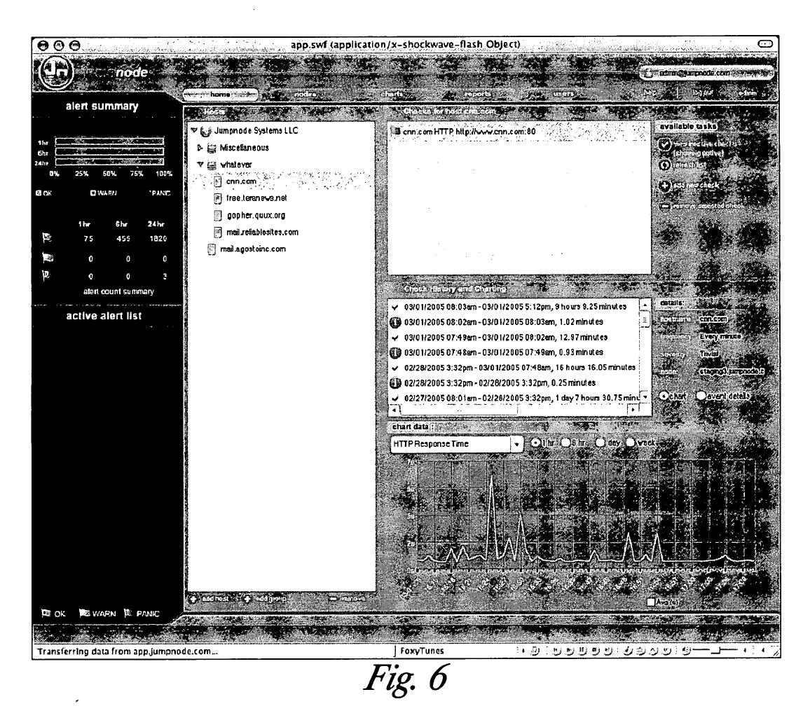

Program instructions executing on the secure servers of the one or more data centers 304-1, . . . , 304-N will compile all of this information into clear, intuitive reports, and graphs (discussed in more detail in connection with FIG. 6) that can be viewed in real time showing usage trends, network bottlenecks, etc. Screens showing the status of the network will be instantly available once the internal monitoring device 316 is connected to the network and begins sending data and/or alerts to the one or more data centers 304-1, . . . , 304-N.

According to various embodiments, each of the one or more data centers 304-1, . . . , 304-N provides redundant, secure storage of a company's data. Therefore, in the unlikely event that one of the one or more data centers 304-1, . . . , 304-N has a problem, another of the one or more data centers 304-1, . . . , 304-N will continue to provide uninterrupted service. As the reader will appreciate, the one or more data centers 304-1, . . . , 304-N can further provide a company with logging and offsite data storage.

To compliment the information supplied by the internal monitoring device 316, the one or more data centers 304-1, . . . , 304-N has the ability to monitor a company's network externally. As mentioned above, this form of“outside” monitoring will help isolate IT issues and will show whether an e-commerce site is functioning optimally, e.g., whether the audience for whom the site is intended, from varying locations, can access the site and use it.

For example, according to the embodiments an internal monitoring device 316 may be receiving network data “internal” to the LAN location 301-1 regarding the various network devices, e.g., web server, mail server 312, etc. The internal monitoring device can be reporting this information up to the one or more data centers 304-1, . . . , 304-N, through one interface or another (as discussed more in FIG. 4), reflecting that the network is up and functioning properly. However, without the present program embodiments executing through web requests to monitor the network location 301-1 from the “outside” in, i.e., external to LAN location 301-1, the company may be wholly unaware that its website is unavailable. Through the present combined embodiments, program instructions can execute on the one or more data centers 304-1, . . . , 304-N to periodically check the website and its performance, etc. Discovering that the website was down would help identify that the issue is not internal to LAN 301-1, but rather an issue with the connection from the external site to the LAN, e.g., a T1 outage with the ISP or some other WAN issue.

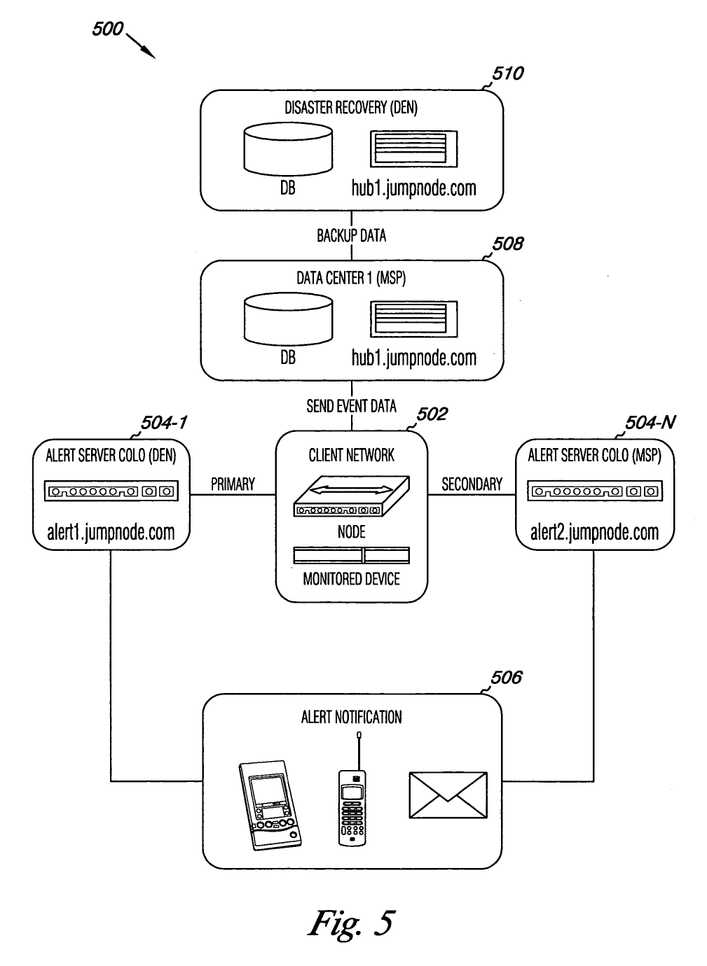

As the reader will appreciate, electronic nodes, e.g., servers located in different geographic regions or even nodes in a remote LAN designed to connect to a company's website from anywhere on the globe (e.g., alert servers 504-1, . . . , 504-N shown and discussed in FIG. 5), can be connected with the one or more data centers 304-1, . . . , 304-N to provide superior information as to the perspective of the audience for whom a particular application/service, website, etc. is intended. Program instructions executing on the one or more data centers 304-1, . . . , 304-N can compile and provide this information to a company, in the form of a “user's perspective score” reflecting what the intended audience really is experiencing.

As another example, a user of a given network, e.g., LAN 301-1, may be reporting difficulty with the network, e.g., email not functioning properly, etc. The company's IT (information technology) administration/administrator may actually be located in a different geographical location, e.g., office 2 (301-2). According to the embodiments, an authorized company user, e.g., network administrator, could access the one or more data centers 304-1, . . . , 304-N through the published website and actually request that the internal monitoring device 316 on network 301-1 attempt to send an email. This will then, very accurately, provide to the network administrator whether the mail server 312 at that location is truly experiencing problems, or whether it is more simply an issue of requesting the network user at location 301-1 to shut-down and reboot their machine.

Exemplary Redundancy to One or More Data Centers

FIG. 4 illustrates a block diagram of a system 400 embodiment showing the redundancy for communicating with one or more data centers. The embodiment of FIG. 4 again illustrates an internal monitoring device 402 (labeled here “J-node”) connected to a company's systems 404, networks 406, and applications 408. As described above in connection with FIGS. 2A-3, the internal monitoring device 402 is built with “out-of-band” connectivity to provide a unique store and forward capability.

In the embodiment of FIG. 4, the internal monitoring device 402 includes cell modem backup capabilities 416 and analog modem backup capabilities 418 to provide connectivity to the Internet 410 and the one or more data centers 412-1, . . . , 412-N. Primarily, the internal monitoring device 402 would communicate information collected on the company's systems 404, networks 406, and applications 408, to the one or more data centers 412-1, . . . , 412-N via the Internet using web requests, e.g., HTTP, as described above. However, if access to the Internet is interrupted, the internal monitoring device 402 will execute instructions to automatically communicate by telephone line 420, e.g., the PSTN (public switched telephone network), through a built in modem 418. This built-in backup prevents data loss in the event of a WAN or other outage.

As shown in FIG. 4, if telephone line service is also interrupted 420, the internal monitoring device 402 will execute instructions to maintain communication through a built in cellular device capability 416. Hence, the embodiments can maintain communication with no denial of service and no alert breakdown. In the unlikely event that all communication methods fail, the internal monitoring device 402 will execute instructions to automatically store all network information for later analysis once the internal monitoring device 402 regains connection to the one or more data centers 412-1, . . . , 412-N. As further illustrated in the embodiment of FIG. 4, the one or more data centers 412-1, . . . , 412-N may additionally be interconnected 414 with one another via a secure connection means, e.g., VPN (virtual private network), etc, to duplicate the data processed and stored on the one or more data centers 412-1, . . . , 412-N for safe archival in a geographically redundant, secure environment.

According to yet another embodiment, program instruction embodiments can be provided which execute to establish a secure transaction layer for an internal monitoring device to the one or more data centers 412-1, . . . , 412-N when all other communication methods fail. This embodiment can provide complimentary redundancy to the above described architecture. For example, in this embodiment, program instructions would execute to create a VPN tunnel only when issues cannot be resolved in the aforementioned manners. In this embodiment, program instructions can issue notifications (see FIG. 5) via email, for example, to provide an appropriate entity the methodology needed to proxy into the newly created temporary VPN to the company's network.

Exemplary Notification and Alerts

FIG. 5 is a block diagram of a system 500 embodiment illustrating notification escalation and alert capabilities. As mentioned above, the embodiments described herein execute instructions to maintain communication between the internal monitoring device attached to a company's/client's network 502 and one or more data centers 508 and 510 with no denial of service and no alert breakdown. In the example embodiment of FIG. 5, data center 510 represents a second backup, e.g., disaster recovery site, to data center 508. For example, data center 510 can maintain offsite backup data and hardware in the event of a physical catastrophe at the primary data center 508. As the reader will appreciate, any number of backup recovery sites can be included in the system embodiments described herein.

The internal monitoring device can execute program instructions to communicate with the one or more data centers 508 and 510 via web requests (i.e., a HTTP web transaction with an encrypted payload), analog modem, and/or cell modem. Thus, the embodiments use a stateless and connectionless method to communicate back to the one or more data centers 508 and 510 without requiring a constant transaction layer connection, e.g. VPN, or other special connectivity. This is a significant advantage over other approaches which need an encrypted communication channel and hardware and software changes to a company's network to facilitate such a communication channel.

Program instructions execute on the one or more data centers 508 and 510 to compile and analyze the information received from a company's/client's network 502. The program instruction embodiments execute to provide converged monitoring, unifying the data from external checks and internal checks. The program instructions execute to take the metrics from each of these types of checks and uses particular algorithms to ascertain what has failed and what the effect is on the company's business. The program instruction embodiments can then execute to issue warnings and alerts through emails, pagers, PDAs, cell phones, Blackberries, laptops, etc, shown at 506.

By way of illustration and not by way of limitation, an alert can be detected based on information gathered from a company's/client's network 502. In the embodiment of FIG. 5, a number of alert servers, 504-1, . . . , 504-N, are provided to the network. Any number of alert servers in remote geographic locations all over the globe can be included in the system embodiments described herein. Thus, FIG. 5 illustrates an alert server 504-1 colocated in Denver, Colo. and in Minneapolis, Minn. Alert server collocations allow for inexpensive redundancy for both network and hardware failures. The same hardware can also be used to perform external monitoring as mentioned in FIG. 3.

In the embodiment of FIG. 5 an internal monitoring device attached to a company's/client's network 502 executes program instructions to send out an alert notification to a first available alert server, e.g., primary alert server 504-1, directly via and alert data bus. According to embodiments, the program instructions execute to cycle through a storable, configurable list of available alert servers, e.g., 504-1, . . . , 504-N, until a connection is established with a ready and available alert server. The alert servers 504-1, . . . , 504-N include program instructions which execute to receive the alert from the internal monitoring device attached to a company's/client's network 502 and/or the one or more data centers 508 and 510. According to embodiments, program instruction embodiments on the alert servers 504-1, . . . , 504-N then execute to look up and cycle through a storable, configurable list of notification information, e.g., emails, pagers, PDAs, cell phones, Blackberries, laptops, etc, stored locally to send out alerts to.

The program instruction embodiments are executable to allow managers to establish schedules for various employees to share “on-call” responsibilities to ensure appropriate coverage and efficient management of employees' time. The program instruction embodiments execute to provide an escalation of the notification procedure up the chain of command in a company as needed. For example, the program instructions execute to ensure that if problems are not resolved within a specific selectably configurable period of time, notification will move up the company's chain of command. Hence, a failsafe procedure is established to ensure problem resolution even if someone along the chain of command drops the ball.

In the embodiment of FIG. 5, the program instructions on the alert servers 504-1, . . . , 504-N will execute to return an alert response to the internal monitoring device attached to a company's/client's network 502 indicating a success and/or failure notifying the intended alert recipient in the company's chain of command. The program instructions will additionally execute to identify who received the alert notification and by what means, e.g., emails, pagers, PDAs, cell phones, Blackberries, laptops, etc. The internal monitoring device attached to a company's/client's network 502 can then execute instructions to send such alert notification resolutions to the one or more data centers 508 and 510. As such, the notification and escalation procedures described herein provide a clear record of who is/was responsible for what event and what action was taken by whom. These embodiments thus allow alerting to occur even if the primary data center is down due to network or hardware issues. It also distributes the intensive load of alert processing to many machines.

Exemplary User Interface

FIG. 6 is a screen shot illustrating a user interface embodiment of system, network, and application monitoring. As mentioned, the embodiments described herein provide a unified view of a company's network, both from inside and outside the network firewall, without requiring any changes to the CPE (customer premise equipment), firewall rules, etc. The program instruction embodiments execute to monitor in real time the status of each system and network component indicated by a customer/client company. Information is displayed on a screen, such as illustrated in FIG. 6, that may be reformatted depending on the sophistication and information needs of the customer.

As shown in the embodiment of FIG. 6, all screen views are clear, uncluttered and intuitive, resulting in ease of use even for non-technical office managers. According to various embodiments, the screenshots, e.g., FIG. 6, use flash media to present information to a user. These attributes are highly attractive to companies with or without fulltime IT staff. According to various embodiments, program instructions execute to refresh the screenshots, e.g., FIG. 6, only when new information is received different from that displayed previously on a given screenshot. That is, the program instructions can execute to verify if the most recent information is being displayed and only refresh if new information is received or something on the company's network and/or system has changed.

The program instructions described herein execute to provide converged monitoring, unifying the data from external checks and internal checks. The program instructions can execute to take the metrics from each of these types of checks and uses particular algorithms to ascertain what has failed and what the effect is on the company's business. The effect on the business is built through the use of dependencies on how each monitored entity interrelates with one another. These dependencies are weighted to help the administrator and/or business person know what the effect is on their business. That is, program instruction embodiments can execute to quantify the severity level of a potential/actual failure or slowdown in a manner that greatly simplifies the network manager's job of sifting through information alerts to prioritize work and ensure immediate attention is given to the most severe problems.

A common problem with existing monitoring products is that they provide information in overwhelming amounts and in a confusing array. Instead of a barrage of streaming data, the program embodiments execute instructions to provide screens which are formatted to cleanly provide only the key data points that a company is interested in seeing. FIG. 6 illustrates how reports and graphs are provided in a clear and easy to understand manner, allowing a user to quickly see problem areas and trends for capacity planning.

For example, in a company with offices/stores/restaurants, etc., throughout the country, the network administrator can see on one screen the countrywide network, zoom in on a trouble spot and locate the source of the trouble. The administrator can also monitor on that same screen the functionality of the company's website, e.g., whether it is viewable, whether it has slow response times, etc. To achieve a comparable level of dependability, competitive offerings would require the establishment of complete monitoring tools in each separate office, which would still leave the administrator without a unified view of all offices on one screen. As mentioned above, previous approaches also leave the user at risk of failure along multiple points in the company's WAN.

As mentioned above, program instruction embodiments described herein will execute to offer trends and benchmarking metrics. Previously, an administrator would be unable to determine, for example, whether his/her network is more or less efficient that those of other comparable companies. Similarly, such individuals would have no manner of knowing whether a Windows-based system has better response time than a Linux-based system, etc. In contrast, according to the present embodiments, information gathered with a company's consent could be redacted to remove company sensitive information and shared on an anonymous basis to further leverage particular industry best practices. These metrics and underlying data will be valuable to both network administrators and market analysts.

Program instructions described in the above architecture can be leveraged to provide a number of products and services such as logging, storage, virus protection, content filtering, etc. Each of these areas alone is a significant market in itself and many-companies have been built around products directed at just one of them. All of these needs, collectively, can be met through the above described embodiments without the introduction of any additional hardware or software on the customer's network other that the straightforward connection of the internal monitoring device thereto.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

For example, the embodiments described above can be used for monitoring and data collection on any type of system. These systems can be computer related or even machines not associated with IT such as a HVAC (heating ventilation and air conditioning) system. The embodiments can also be used to gather business process parameters in a real time fashion and display them on a web browser anywhere in the world. The embodiments can be used as a diagnostic tool shipped out to a customer to gather statistics, which may help determine if a future install is feasible. The embodiments can be used as an alternative method to reach the internet through the use of the internal monitoring device's cellular and/or analog modem.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A network device, comprising:
a processor; and
a memory coupled to the processor, wherein the memory includes program instructions storable by the memory and executable by the processor to:
monitor a network internally; and
report information collected by the device to an external data center using a stateless connection.

2. The device of claim 1, wherein the device includes program instructions which execute to independently probe the network for devices to monitor.

3. The device of claim 1, wherein the device includes program instructions that execute to receive updates to features and operating system program instructions from the external data center using the stateless connection.

4. The device of claim 3, wherein the device is a diskless and fanless hardware device and wherein memory includes a NAND flash memory capable of storing program instructions received from the data center.

5. The device of claim 1, wherein the program instructions include operating system instructions designed around a Linux kernel.

6. The device of claim 1, wherein the device includes program instructions that execute to compress and encrypt information collected by the device.

7. The device of claim 1, wherein the device includes program instructions that execute to monitor the network according to protocols selected from the group of:
simple network management protocol (SNMP) to get statistics such as disk usage, processor usage, memory allocation;
hypertext transport protocol (HTTP);
file transfer protocol (FTP);
transmission control protocol/internet protocol (TCP/IP);
user datagram protocol (UDP);
file transfer protocol (FTP); and
internet control message protocol (ICMP).

8. The device of claim 1, wherein the device is part of a system architecture including the stateless connection capability between the device and the data center, wherein the data center includes program instructions that execute to:
monitor the network externally using the stateless connection; and
compile the information collected by the device with information collected from external data center monitoring in order to unify the information and apply metrics thereto reflecting dependencies on how each monitored entity interrelates.

9. The device of claim 1, wherein the device and the data center include program instructions that execute to issue notifications to fat and thin computing devices according to a selectable escalation hierarchy, the fat and thin computing devices selected from the group of:
laptops;
personal digital assistants (PDAs);
desktops;
cell phones;
email addresses;
pagers;
Blackberries; and
short message service (SMS) devices.

10. The device of claim 1, wherein the device includes an analog modem and a cellular capability, and wherein the program instructions execute to report information to the data center using the analog modem and the cellular capability when an Internet connection to the data centers is unavailable.

11. The device of claim 10, wherein the data center includes program instructions to create a secure transaction layer with the network when communication to the device is unavailable through the Internet, the analog modem, and the cellular capability.

12. A monitoring system, comprising:
an internal monitoring device connected to a network inside of the network's firewall without changes to the network's software or firewall;
a remote data center including program instructions that execute to analyze and present through a published website monitoring information received internally and externally from the network; and
means to externally monitor the network and to communicate internal network monitoring information to the data center in a stateless manner.

13. The system of claim 12, wherein system includes a number of servers located in different geographic locations and connected to the remote data center, wherein the number of servers include program instructions that execute to:
monitor websites, ecommerce sites, file transfer servers, and mail server of the network; and
provide a user's perspective score to the remote data center.

14. The system of claim 13, wherein the number of servers include program instructions that execute to receive network alert information and to notify selectable fat and thin computing devices according to a selectable escalation hierarchy as well as to record notification resolutions at the data center.

15. A method for network monitoring, comprising:
internally monitoring a network using a diskless and fanless hardware device;
externally monitoring the network using a stateless connection;
communicating internal network monitoring information to a third party data center using the stateless connection; and
converging external monitoring information and internal monitoring information on the network into a unified view.

16. The method of claim 15, wherein the method includes providing out-of-band connectivity connections for communicating the internal network monitoring information to the third party data center when the stateless connection is unavailable.

17. The method of claim 15, wherein the method includes issuing notifications to a number of fat and thin computing devices according a defined escalation hierarchy.

18. The method of claim 15, wherein the method includes internally monitoring a number of geographically separate networks, each using a diskless and fanless hardware device, and communicating the internal monitoring information to the third party data center.

19. The method of claim 15, wherein the method includes providing program instruction updates to the diskless and fanless hardware device from the third party data center using a stateless connection.

20. The method of claim 15, wherein the method includes initiating a request, from a geographically different network, for the diskless and fanless hardware device on the network being monitored to perform a network event.

21. The method of claim 15, wherein the method includes providing industry benchmarking metrics based on external and internal monitoring information obtained from a number of different networks and systems.

22. The method of claim 15, wherein the method includes using external monitoring information obtained from a number of different geographic locations to provide a user's perspective score.

23. A computer readable medium having instructions executable for causing a device to perform a method, comprising:
storing dependencies which reflect how various network entities interrelate and how a network event on one entity effects other entities on a particular local area network (LAN) and a particular wide area network (WAN); and
applying weighted metrics to information received from internal network monitoring and external network monitoring to recognize issues within a network based on the stored dependencies.

24. The medium of claim 23, wherein the instructions are executable to establish schedules for various individuals to share on-call responsibilities relating to network events.

25. The medium of claim 23, wherein the instructions are executable to quantify and prioritize an indication of a potential failure on the LAN and WAN.

26. The medium of claim 23, wherein the instructions are executable to issue notifications according to an escalation procedure and to record who is responsible for what responsive actions and record what responsive actions were taken by whom.

27. The medium of claim 23, wherein the instructions are executable to store historical data for safe archival in a geographically redundant secure environment.

28. A method for facilitating network monitoring, comprising:
making available a hardware device useable for internal network monitoring, wherein the device is connectable to a network without requiring any software reconfiguration to the network, and wherein the device can exchange information with a data center external to the network in a stateless manner; and
facilitating a purchase of the device via a website.

29. The method of claim 28, wherein the method includes facilitating the purchase to an entity selected from the group of:
a value added reseller;
a purchaser internal to a company;
a purchaser external to a company;
a third party.

30. The method of claim 29, wherein the method includes program instructions executable via the website to download software tools to the entity, wherein the software tools include program instructions that can execute to:
probe the network for network items to monitor; and
logically determine which network items should and should not be monitored.
